(19) United States
(12) Patent Application Publication
(10) Pub. No.: US 2025/0037601 A1
(43) Pub. Date: Jan. 30, 2025

(54) TRAINING SYSTEM

(71) Applicant: FABBRICA D'ARMI PIETRO BERETTA S.P.A., Gardone Val Trompia (Brescia) (IT)

(72) Inventors: Marco BASSOLI, Gardone Val Trompia (Brescia) (IT); Giacomo ZILIANI, Gardone Val Trompia (Brescia) (IT); Giulio BONETTI, Gardone Val Trompia (Brescia) (IT)

(21) Appl. No.: 18/714,150

(22) PCT Filed: Oct. 7, 2022
(86) PCT No.: PCT/IB2022/059593

§ 371 Date: May 29, 2024

(30) Foreign Application Priority Data
Dec. 23, 2021 (IT) 102021000032489

(51) Int. Cl. G09B 9/00

(52) U.S. Cl. CPC G09B 9/003

(57) ABSTRACT

A training system for using a firearm is provided. The training system has a training region having fixed or movable targets, a firearm, user detection groups for detecting user physical status data, firearm detection groups for detecting firearm status data, and target detectors for detecting target data. A data management and analysis unit, operatively connected to the user detection groups, to the firearm detection groups and to the target detectors, is suitable for receiving the user physical status data, the firearm status data and the target data, and is configured to create a virtual training model as a function of set/stored user features, as a function of set/stored environmental features, as a function of set/stored training session features, and as a function of expected results, to compare the user physical status data, the firearm status data and the target data with the virtual training model.

The present invention relates to a training system for using a firearm. Furthermore, the present invention relates to a training method using said system.

In particular, but not in a limiting manner, the present invention pertains to the defense sector.

It is clearly of importance to be as trained as possible in the use of a firearm. In fact, the use of a firearm contextualizes a situation of potential danger both for those who use it and for those who are in proximity to the user. More training corresponds to more limited and contained potential danger. It is only practice and constant training that confers to the user of the firearm the experience necessary in order to exploit it effectively and to use it safely.

It is therefore known in the prior art to find solutions to train, or coach, people and/or law enforcement agencies and/or the military in the use of firearms.

The more training, or coaching, takes place, under conditions that are similar to actual conditions, the greater the preparation and benefit derived by the user and those around them, limiting as much as possible a potentially hazardous situation.

In the prior art, training sessions are given by instructors who monitor the performance of users/students, detecting and verifying any situations to be improved.

At the same time, with known training systems, in addition to the feedback of the instructor, during a training session the user experiences personal feelings and has feedback when it hits, or misses, a target.

Such training systems, therefore, present a multiplicity of problems.

First of all, the attention of the instructor must always be maximum and must always be directed at the user. It is therefore not uncommon for an instructor to miss certain events and not be able to give complete feedback. This problem is also exacerbated in group training sessions and/or training sessions that take place in training regions with extensive metrics.

Secondly, the user experiences sensations that remain only in their head and that are difficultly transmissible and/or are used as a common factor.

The need to provide a training system that solves these problems is therefore strongly felt turning out to be extremely useful and versatile for both users and instructors.

The object of the present invention is to provide a training system that solves said need.

Such object is achieved by means of the training system claimed in claim 1. Similarly, such object is achieved by means of a training method according to claim 14. The claims dependent thereon describe preferred variant embodiments involving further advantageous aspects.

Further features and advantages of the invention will become clear from the description given below of its preferred embodiments as non-limiting examples, in reference to the attached figures, wherein:

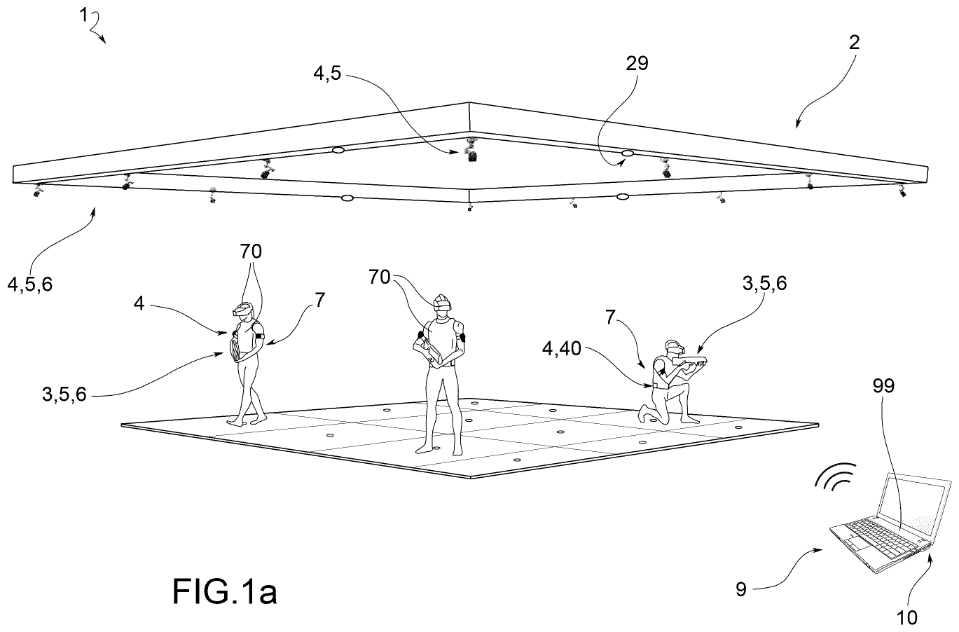

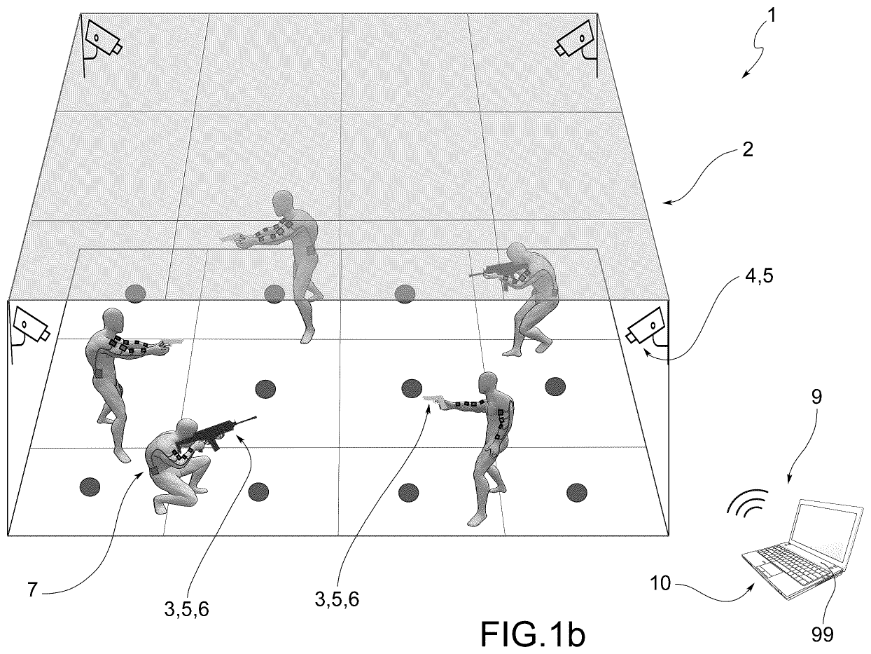

FIGS. 1a and 1b show two schematic views relating to training systems according to the present invention;

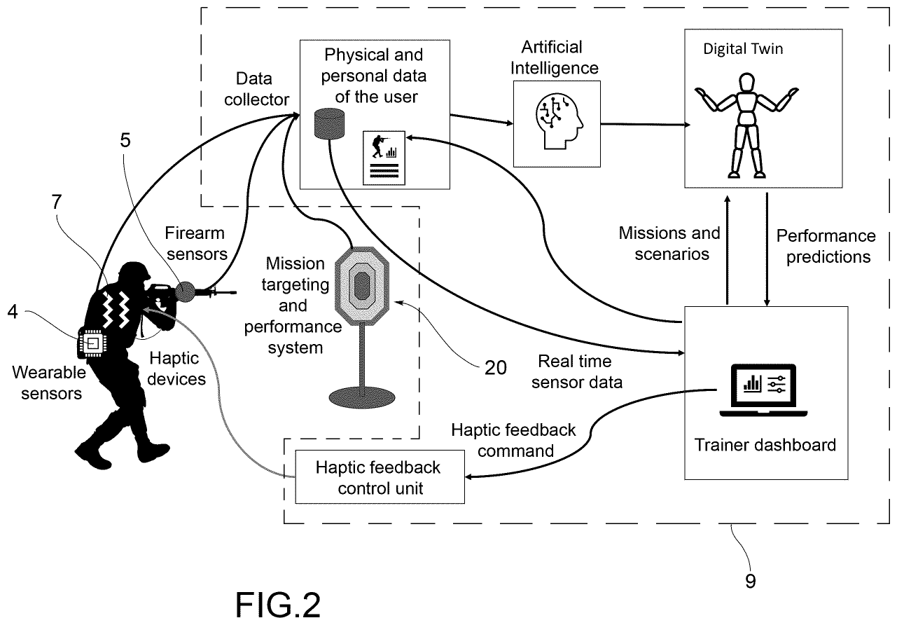

FIG. 2 shows a schematic diagram of the operating logic of the training system according to a preferred embodiment;

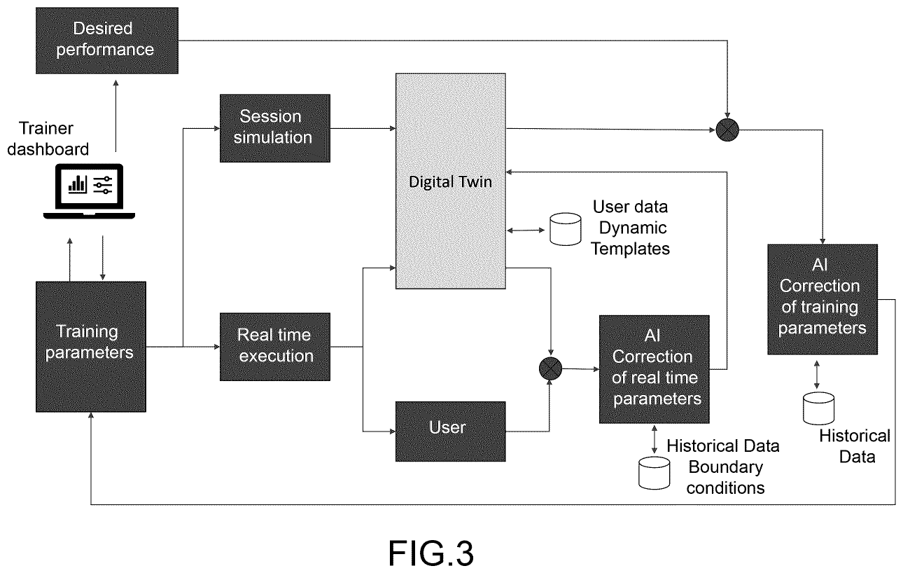

FIG. 3 shows a schematic diagram of the operating logic of the training system according to a preferred embodiment.

With reference to the accompanying figures, with the reference number 1 is indicated a training system 1 for using a firearm according to this invention.

The training system 1 comprises a training region 2, in which training sessions are performable.

The training region 2 is such that the user is free to perform movements, displacements, and similar.

The training region 2 comprises fixed or movable targets 20.

Furthermore, the training region 2 comprises training region status sensors 29 that are suitable for detecting region environmental conditions, e. g., temperature, humidity, wind, and similar.

According to a preferred embodiment, the training region 2 is an actual outdoor area habitable by one or more users.

According to a preferred embodiment, the training region 2 is an area virtualized by a user. Preferably, in such a preferred embodiment, the targets are virtualized.

In addition, the training system 1 comprises a firearm 3, which is wieldable by the user.

By means of such a firearm 3, the user has to hit the targets 20 provided in the training region 2.

According to a preferred embodiment, the firearm 3 is a real firearm.

According to a further preferred embodiment, the firearm 3 is a simulacrum firearm.

Depending on the type of training region 2, the type of firearm 3 to be used also varies.

According to the present invention, the training system 1 comprises user detection means 4 suitable for detecting user physical status data during a training session.

According to a preferred embodiment, the user detection means 4 comprise a cardiac status detection group, preferably suitable for detecting the user's heartbeat and/or electrocardiogram.

According to a preferred embodiment, the user detection means 4 comprise a sweat detection group, preferably suitable for detecting the galvanic response of the user's skin (GSR).

According to a preferred embodiment, the user detection means 4 comprise a respiratory status detection group, preferably suitable for detecting the respiratory rate.

According to a preferred embodiment, the user detection means 4 comprise a limb status detection group, preferably suitable for performing a myography of the limbs and of the main muscles of the limbs.

According to a preferred embodiment, the user detection means 4 comprise a position detection group, preferably suitable for detecting the user's position in the training region 2.

According to a preferred embodiment, the user detection means 4 comprise a user activity detection group, preferably suitable for detecting the user's speed and/or acceleration and/or angular speed in the training region 2.

According to a preferred embodiment, the user detection means 4 are positioned on the user, e.g., worn by the user.

According to a preferred embodiment, the user detection means 4 are positioned remotely with respect to the user, e.g., positioned in the training region 2.

According to a preferred embodiment, the user detection means 4 are positioned both on the user and in the training region 2.

According to the invention, the training system 1 comprises firearm detection means 5 suitable for detecting firearm status data.

According to a preferred embodiment, the training system 1 the firearm detection means 5 comprise a firearm status detection group, preferably suitable for detecting the operational status of the firearm, for example the presence thereof in the holster, or the aiming thereof.

According to a preferred embodiment, the training system 1 the firearm detection means 5 comprise a firearm configuration detection group, preferably suitable for detecting the safe configuration thereof, or the configuration thereof in semi-automatic or automatic mode, or the armed configuration thereof.

According to a preferred embodiment, the training system 1 the firearm detection means 5 comprise a firearm grip detection group, preferably suitable for detecting the modes in which the firearm is gripped by the user.

According to a preferred embodiment, the training system 1 the firearm detection means 5 comprise a trigger guard engagement detection group, preferably suitable for detecting the presence of the user's finger in the firearm's trigger guard.

According to a preferred embodiment, the training system 1 the firearm detection means 5 comprise a shooting and shooting mode detection group, preferably suitable for detecting the shooting of the firearm and/or the modes, e.g., the actuation on the trigger performed by the user.

According to a preferred embodiment, the training system 1 the firearm detection means 5 comprise a firearm activity detection group, preferably suitable for detecting speed and/or acceleration and/or angular speed of the firearm 3 in the training region 2.

According to a preferred embodiment, the firearm detection means 5 are positioned on the firearm.

According to a preferred embodiment, the firearm detection means 5 are positioned remotely in respect to the firearm, for example positioned in the training region 2.

According to a preferred embodiment, the firearm detection means 5 are positioned both on the firearm and in the training region 2.

According to the present invention, the training system 1 comprises target detection means 6 suitable for detecting target data.

According to a preferred embodiment, the target detection means 6 are suitable for detecting whether and how a shot performed with the firearm 3 hit the target 20.

According to a preferred embodiment, the target detection means 6 are positioned on the user.

According to a preferred embodiment, the target detection means 6 are positioned on the firearm.

According to a preferred embodiment, the target detection means 6 are positioned in the training region 2 positioned on the target 20.

According to a preferred embodiment, the target detection means 6 are positioned on the user, on the firearm, and in the training region.

According to a preferred embodiment, the training system 1 comprises devices wearable by the user 7, comprising haptic devices 70 suitable for producing haptic signals on the user.

Preferably, said haptic devices 70 are suitable for simulating, for example by means of an electrical signal or a vibratory signal, the recoil and/or noise of a shot. Preferably, such a solution is usable for simulating determined behaviors typical of a real firearm in a situation wherein a simulacrum firearm is used.

According to the present invention, the training system 1 comprises a data management and analysis unit 9.

The data management and analysis unit 9 is operatively connected to the user detection means 4, to the firearm detection means 5 and to the target detection means 6 and is therefore suitable for receiving the user physical status data, the firearm status data and the target data. That is to say, the data management and analysis unit 9 receives all data detected by the user detection means 4 and therefore receives all information relating to the physical state of the user, for example, heart status, speed, etc. That is to say that the data management and analysis unit 9 receives all of the data detected by the firearm detection means 5 and therefore receives all of the information relating to the status of the firearm, for example the grip, inclination, etc. That is to say that the data management and analysis unit 9 receives all of the data detected by the target detection means 6 and therefore receives all of the information relating to the targets, for example target hit, target missed, etc.

According to a preferred embodiment, the data management and analysis unit 9 is operatively connected to the user detection means 4 by means of physical connections and/or wiring.

According to a preferred embodiment, the data management and analysis unit 9 is operatively connected to the user detection means 4 by means of wireless connections.

According to a preferred embodiment, the data management and analysis unit 9 is operatively connected to the firearm detection means 5 by means of physical connections and/or wiring.

According to a preferred embodiment, the data management and analysis unit 9 is operatively connected to the firearm detection means 5 by means of wireless connections.

According to a preferred embodiment, the data management and analysis unit 9 is operatively connected to the target detection means 6 by means of physical connections and/or wiring.

According to a preferred embodiment, the data management and analysis unit 9 is operatively connected to the target detection means 6 by means of wireless connections.

According to a preferred embodiment, the data management and analysis unit 9 comprises a memory 99 in which all of the data are storable.

According to the invention, the data management and analysis unit 9 is configured to create a virtual training model as a function of set/stored user features, for example coming from theoretical models resulting from scientific studies, as a function of set/stored environmental features, as a function of set/stored training session features, and as a function of the expected results, for comparing the user physical status data, firearm status data and target data with the virtual training model.

In other words, the data management and analysis unit 9 creates a virtual training model starting from of the data received. The virtual training model presents all the information relating to the user, the firearm and the training region.

According to the present invention, the virtual training model is compared with the detected data: as a function of said received data and said comparison between the model and the received data, the result of the training session is determined and any eventual points to be improved in order to improve the results are identified.

For example, it is determined whether the physical status of the user should or should not be improved.

For example, it is determined whether the use of the firearm should or should not be improved.

For example, it is determined whether the aim should or should not be improved.

In this way, any eventual user deficiencies are highlighted and specific ad hoc training sessions may be provided, aimed at improving such determined deficiencies.

According to a preferred embodiment, the data management and analysis unit 9 for each training session collects the user physical status data, the firearm status data and the target data, and collects the data in a memory.

Preferably, the data management and analysis unit 9 updates the set/stored user features, the set/stored environmental features, and the set/stored training session features and updates the virtual training model in order to compare new user physical status data, firearm status data and target data collected with the updated virtual training model.

According to a preferred embodiment, the data management and analysis unit 9 updates the virtual training model between one training session and another.

According to a preferred embodiment, the data management and analysis unit 9 updates the virtual training model during a training session.

According to a preferred embodiment, the data management and analysis unit 9 sets a training session in function of the initial physical user status data.

For example, the data management and analysis unit 9 sets a training session for a young user with certain targets, while sets a training session for an older user with different targets.

According to a preferred embodiment, the data management and analysis unit 9 sets a training session based on the expected results.

For example, the data management and analysis unit 9 sets a training session with a multiplicity of targets with the aim of improving the results of a user.

According to a preferred embodiment, the data management and analysis unit 9 is for example a computer, a tablet, a smartphone, or a workstation.

According to a preferred embodiment, the data management and analysis unit 9 is connectable to a further external electronic device, for example a computer, a tablet, a smartphone, wherein, through said external device 10, the data in the data management and analysis unit 9 is accessible, modifiable and integrable, for modifying the virtual training model.

According to a further preferred embodiment, the data management and analysis unit 9 is the external electronic device 10 itself.

According to a preferred embodiment, the firearm 3 is a simulacrum firearm, wherein the training system 1 comprises devices wearable by the user 7, comprising haptic devices 70 suitable for producing haptic signals on the user 70, wherein said device wearable by the user 7 is operatively connected to the data management and analysis unit 9, wherein the data management and analysis unit 9 controls the actuation of the haptic devices 70.

That is to say, the training system 1 simulates a situation as real as possible in function of what is required.

According to a preferred embodiment, the training region 2 comprises training region status sensors 29 suitable for detecting region environmental conditions, e.g., temperature, humidity, wind, and similar.

Preferably, the data management and analysis unit 9 updates the virtual training model as a function of what is detected by the training region status sensors 29.

As mentioned, it is an object of the present invention also a training method for using a firearm by means of a training system 1 having the characteristics described above.

According to the present invention, the method comprises the steps of:
detecting the user physical status data, firearm status data and target data;
creating a virtual training model as a function of set/stored user features, e.g., coming from theoretical models resulting from scientific studies, as a function of set/stored environmental features, as a function of set/stored training session features and as a function of the expected results;
comparing the user physical status data, the firearm status data and the target data with the virtual training model.

Furthermore, according to a preferred embodiment, the training method further comprises the step of:
collecting the user physical status data, the firearm status data and the target data;
updating the set/stored user features, the set/stored environmental features, and the set/stored training session features;
updating the virtual training model to compare new collected user physical status data, firearm status data and target data with the updated virtual training model.

According to a preferred embodiment, the step of updating the virtual training model is performed between one training session and the other.

According to a preferred embodiment, the step of updating the virtual training model is performed during a training session, in real time.

Innovatively, the training system and the training method largely fulfill the purpose of the present invention in overcoming the problems that are typical of the prior art.

Advantageously, in fact, the training system and the training method are suitable for performing effective training for users, as well as for giving clear support to the activity of instructors.

Advantageously, both the user and the instructor obtain complete data regarding a training session. Advantageously, the user, but also the same instructor, both obtain a complete comparison with the virtual training model.

Advantageously, the strengths and weaknesses of the user are highlighted during an entire training session.

Advantageously, the training system has also predictive character, predicting the results that are expected from a user compared to a desired training situation, for example simulating a certain type of mission.

Advantageously, the training system has also certifying character: a training session is classifiable as “passed”/“not passed” in function of the results achieved by the user with respect to the expected results.

Advantageously, the virtual training model is suitable for predicting a series of user/firearm/training region situations.

Advantageously, the training system recognizes and manages different situations.

Advantageously, the training system is settable in function of the features, such as the age or experience, of the user.

Advantageously, the training system is settable in function of the features, such as the type or caliber, of the firearm.

Advantageously, the training system is settable in function of the features, such as the temperature or wind, of the training region.

Advantageously, the training region may be small in size and may also be performed indoors.

Advantageously, the training is virtualizable.

Advantageously, the training is performable in groups, presenting real people in the same training region or presenting within a virtual reality people using, remotely, different training systems.

It is clear that a person skilled in the art, in order to satisfy contingent needs, could make modifications to the training system described above, all being contained within the scope of protection as defined in the following claims.

1. A training system for using a firearm, comprising:
a training region, in which training sessions are executable, wherein the training region comprises fixed or movable targets;
a firearm;
user detection means suitable for detecting user physical status data;
firearm detection means suitable for detecting firearm status data;
target detection means suitable for detecting target data; and
a data management and analysis unit, operatively connected to the user detection means, to the firearm detection means and to the target detection means, suitable for receiving the user physical status data, the firearm status data and the target data, wherein the data management and analysis unit is configured to create a virtual training model, as a function of set/stored user features, as a function of set/stored environmental features, as a function of set/stored training session features, and as a function of expected results, to compare the user physical status data, the firearm status data and the target data with the virtual training model.

2. The training system of claim 1, wherein the data management and analysis unit comprises a memory and for each training session, the data management and analysis unit collects, in the memory, the user physical status data, the firearm status data and the target data, and updates the set/stored user features, the set/stored environmental features, the set/stored training session features and the virtual training model for comparing collected new user physical status data, new firearm status data and new target data with the updated virtual training model.

3. The training system of claim 2, wherein the data management and analysis unit updates the virtual training model between one training session and the other and/or during a training session in real time.

4. The training system of claim 1, wherein the data management and analysis unit sets a training session as a function of initial user physical status data and/or as a function of the expected results.

5. The training system of claim 1, wherein the data management and analysis unit is connected to an external electronic device, and wherein, through said external electronic device, the data in the data management and analysis unit is accessible, modifiable and integrable, for modifying the virtual training model.

6. The training system of claim 1, wherein the firearm is a simulacrum firearm, wherein the training system further comprises devices wearable by a user and comprising haptic devices suitable for producing haptic signals on the user, wherein said devices wearable by the user are operatively connected to the data management and analysis unit, and wherein the data management and analysis unit controls an actuation of the haptic devices.

7. The training system of claim 1, wherein the user detection means comprise:
a cardiac status detection group suitable for detecting a user's heartbeat and/or electrocardiogram;
a respiratory status detection group suitable for detecting a respiratory rate;
a sweat detection group suitable for detecting a galvanic skin response (GSR);
a limb status detection group suitable for performing a myography of limbs and main muscles of the limbs;
a position detection group suitable for detecting the user's position in the training region; and
a user activity detection group suitable for detecting at least one of the user's speed, acceleration, or angular speed in the training region.

8. The training system of claim 7, wherein the user detection means are positioned on the user and/or are remote with respect to the user.

9. The training system of claim 1, wherein firearm detection means comprise:
a firearm status detection group suitable for detecting an operating status of the firearm, including presence of the firearm in a holster, or pointing of the firearm;
a firearm configuration detection group suitable for detecting safe configuration of the firearm, or configuration of the firearm in a semi-automatic or automatic mode, or an armed configuration of the firearm;
a firearm grip detection group suitable for detecting modes in which the firearm is gripped by a user;
a trigger guard engagement detection group suitable for detecting presence of the user's finger in a trigger guard of the firearm;
a shooting and shooting mode detection group suitable for detecting shooting of the firearm and/or shooting modes; and
a firearm activity detection group suitable for detecting at least one of speed, acceleration, or angular speed of the firearm in the training region.

10. The training system of claim 9, wherein the firearm detection means are positioned on the firearm and/or are remote with respect to the firearm, optionally the firearm detection means being positioned in the training region.

11. The training system of claim 1, wherein the target detection means are suitable for detecting whether and how a shot performed with the firearm hits a target.

12. The training system of claim 11, wherein the target detection means are positioned on a user and/or on the firearm, and/or the target detection means are remote with respect to the firearm, optionally the target detection means being positioned in the training region and/or on the targets.

13. The training system of claim 1, wherein the training region comprises training region status sensors suitable for detecting region environmental conditions, including temperature, humidity, and wind, and wherein the data management and analysis unit updates the virtual training model as a function of what is detected by the training region status sensors.

14. A training method for using a firearm by a training system comprising:
a training region, in which training sessions are executable, wherein the training region comprises fixed or movable targets;
a firearm;
user detection means suitable for detecting user physical status data;
firearm detection means suitable for detecting firearm status data;
target detection means suitable for detecting target data; and
a data management and analysis unit, operatively connected to the user detection means, to the firearm detection means and to the target detection means, suitable for receiving the user physical status data, the firearm status data and the target data, wherein the data management and analysis unit is configured to create a virtual training model, as a function of set/stored user features, as a function of set/stored environmental features, as a function of set/stored training session features, and as a function of expected results, to compare the user physical status data, the firearm status data and the target data with the virtual training model,
the method comprising:
detecting the user physical status data, the firearm status data and the target data;
creating a virtual training model as a function of set/stored user features, as a function of set/stored environmental features, as a function of set/stored training session features and as a function of the expected results; and
comparing the user physical status data, the firearm status data and the target data with the virtual training model.

15. The training method of claim 14, further comprising
collecting the user physical status data, the firearm status data and the target data;
updating the set/stored user features, the set/stored environmental features, the set/stored training session features; and
updating the virtual training model to compare new collected user physical status data, new firearm status data and new target data with the updated virtual training model.

16. The training method of claim 15, wherein updating the virtual training model is performed between one training session and the other, and/or during a training session in real time.

17. The training system of claim 5, wherein the external electronic device is a computer, a tablet, or a smartphone.

18. The training system of claim 8, wherein the user detection means are worn by the user.

19. The training system of claim 8, wherein the user detection means positioned in the training region.

20. The training system of claim 9, wherein the shooting and shooting mode detection group is suitable for detecting an actuation on a trigger performed by the user.
